(19) United States
(12) Patent Application Publication
(10) Pub. No.: US 2015/0039443 A1
(43) Pub. Date: Feb. 5, 2015

(54) ENGAGEMENT POINT MANAGEMENT SYSTEM

(71) Applicant: Nant Holdings IP, LLC, Culver City, CA (US)

(72) Inventor: Patrick Soon-Shiong, Los Angeles, CA (US)

(21) Appl. No.: 14/449,848

(22) Filed: Aug. 1, 2014

Related U.S. Application Data
(60) Provisional application No. 61/861,078, filed on Aug. 1, 2013.

(51) Int. Cl. G06Q 30/02; G06F 17/30

(52) U.S. Cl. CPC G06Q 30/0269; G06F 17/30528
USPC 705/14.66

(57) ABSTRACT

Engagement point management systems are presented. A consumer's behavior can be observed via one or more digital representations. The observed behaviors can be mapped to an expected behavior pattern constructed from individual engagement points. Each engagement point represents a possible communication channel between a third party content provider and the consumer. When a consumer is found within an engagement point, context information associated with the consumer can be matched with contexts of the third party's content.

This application claims the benefit of priority to U.S. provisional application 61/861,078 filed on Aug. 1, 2013. This and all other extrinsic references referenced herein are incorporated by reference in their entirety.

### FIELD OF THE INVENTION

The field of the invention is engagement point management systems, methods and computer related products.

### BACKGROUND

The background description includes information that can be useful in understanding the present invention. It is not an admission that any of the information provided herein is prior art or relevant to the presently claimed invention, or that any publication specifically or implicitly referenced is prior art.

Personalized marketing targeting consumers through providing personalized content is widely acknowledged as being more effective than general public marketing through providing standardized content across the spectrum of consumers. Typically, when seeking to purchase an item a consumer flows through various mental states to reach a final purchase decision. However, the decision processes and mental states are not uniform among consumers. Further each consumer has different circumstantial factors that would affect their decision-making. Such non-uniformities among consumers arise from numerous factors including diversity, age variance, gender/sexual difference, context, or geographical/cultural difference. Such diversity among consumers creates severe problems in effective delivery of an advertiser's messages to the consumer. A single message might be delivered to many unreceptive consumers because such content providers are unable to adequately match their messages with each consumer's state of mind. Content providers would benefit from having greater insight into a consumer's “blueprint” of an expected decision-making behavior in order to provide more targeted messages. Yet, currently available personalized marketing systems are mainly focused on providing personal content at a priori defined trigger points (i.e. offering personalized coupons for purchase at the time of consumer's comparison among sellers.). However, such marketing systems are not flexible enough to adapt to changes in variable consumer behaviors or needs because each consumer can follow their own path.

Others have put forth effort toward developing systems and methods for providing personal content to consumers more effectively by constructing a personalized decision-path or touchpoints based on consumer behavior data. For example, U.S. patent application 2008/0046267A1 to Romano titled “System and Method for Consumer Touchpoint Management,” published Feb. 21, 2008, discusses a system and method for consumer touchpoint management, which discloses an automated method for managing, delivering, and tracking dynamic content. Romano further discloses that consumer data including past behavior of consumers are useful to classify consumers into one or more segments for targeted marketing. However, Romano only discusses a group targeting method after classification of individual consumers into groups, and does not discuss a personalized targeting method in relation to managing consumer touchpoints. Furthermore, Romano's consumer touchpoints are limited to a single modality of touchpoint, which represents only a slice of the consumer experience. Similarly, U.S. Pat. No. 6,012,051 to Sammon titled “Consumer Profiling System with Analytic Decision Processor,” issued Jan. 4, 2000, discusses a system to allow a user to make a best choice according to the user's own personal profile in making a purchasing decision. Yet, Sammon's disclosure is also limited to consumer's purchase decision, which is also a single aspect of consumer experience or decision making process.

In another example, an international PCT application WO 2013/062744A1 to Ouimet titled “Commerce System and Method of Controlling the Commerce System Using Personalized Shopping List and Trip Planner,” published on May 2, 2013 discusses an interaction between consumer and seller based on the consumer's behavior for particular products. Ouimet provides the consumer personalized content including generating a list of recommended products or promotional offers by a personal assistant engine. However, Ouimet also does not discuss how to identify or manage a consumer's decision behavior process.

U.S. Pat. No. 8,412,656 to Baboo titled “Methods and Systems for Building a Consumer Decision Tree in a Hierarchical Decision Tree Structure based on In-Store Behavior Analysis,” issued Apr. 2, 2013, discusses a hierarchical decision tree structure comprising nodes and edges, where nodes represent state-of-mind of the consumer and edges represent the transition of the decision. Baboo further discusses that a decision path of consumers is obtained by combining a behavior data with the category layout and transaction data based on observed actual in-store purchase behavior. However, Baboo's system is limited to a predefined number of nodes, which can not reflect consumer's actual expected behavior pattern in decision-making in its entirety.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for system, device, and method capable of constructing a consumer engagement system for personal marketing, which derives an expected behavior pattern of a consumer from consumer behavior data and provides multiple channels to content providers to interact with consumers. Such systems map personalized content directly to a consumer's inferred mind sets via contextually relevant engagement points.

### SUMMARY OF THE INVENTION

The inventive subject matter provides apparatus, systems and methods in which one can manage a consumer's engagement points to provide personalized content to the consumer as the consumer flows through an expected behavior pattern. One aspect of the inventive subject matter includes an engagement point management system comprising an engagement point database and an engagement engine coupled with the engagement point database. The engagement point database stores one or more engagement points that represent opportunities for third parties to engage with the consumer based on the consumer's mental, physical states, or activities in which consumer engages. The engagement points can correspond to one or more states, possibly including a consumer state, an environment state, a device state, a consumer state of mind, a physical place, or other state. Engagement points can be considered distinct manageable objects through which third parties can electronically engage the consumer with contextually relevant content. The engagement points can be created or modified by the engine, or deleted from the database by the engine as desired.

The engagement engine uses engagement points stored in the engagement point database to construct an expected behavior pattern representing an expected set of behavior activities that the consumer is expected to experience as they flow through their decision making process. The engine is configured to obtain consumer behavior data (e.g., geographic location data, image data, smell data, sound data, ambient data, etc.) from one or more devices (e.g. a cell phone, a GPS, a digital camera, a sound recording device, a scanning device, a biometric device, etc.). The engine can derive a context from the consumer behavior data. For example, by obtaining consumer's location data through a GPS, the engine can derive information about the consumer's possibly preferred shopping location. Based on the behavior context, the engine can acquire a set of engagement points from the engagement point database and link the engagement points together according to a behavior rule set to instantiate a consumer's expected behavior pattern. The engine is further configured to create a content delivery channel between one or more content providers and the consumer by providing the content providers a user interaction interface to the engagement point construct (e.g., an API, a session, a port, a web service, etc.). Through the instantiated channel and via the user interface, the engine allows content providers to present content to consumers via a user interaction interface when the consumers are engaged in an engagement point.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an engagement point management system.

FIG. 2 is an exemplary schematic of consumer expected behavior pattern.

FIG. 3 is a method schematic of providing personalized content to a consumer via instantiated engagement points.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed. Moreover, and as used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, the terms the terms “coupled to” and “coupled with” are used euphemistically in a networking context to mean “communicatively coupled with” where two or more devices are configured to exchange data (e.g., uni-directionally, bi-directionally, peer-to-peer, etc.) with each other possibly via one or more intermediary devices.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention can contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. Contemplated software instructions can be embodied as a computer program product comprises a non-transitory, tangible computer readable medium storing the software instructions that are configured to cause one or more processors to execute the steps of the instructions. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion describes a computer-based ecosystem that maps inferred mind sets of consumers to engagement points for third party content. A consumer is observed through collection of digital representations of the consumer's environment. The systems and engines disclosed herein generate a context associated with the consumer based on the digital representation. The context could be a collection of attribute-value pairs, or an a priori context, “Shopping” for example. The system leverages the context to build an expected behavior pattern associated with the context. Using the “Shopping” example, the expected behavior pattern could include the following expected activities or states: “Browsing”, “Comparing”, “Purchasing”, “Evaluating”, and “Returning”. Each of these states represents a possible engagement point. In the following discussion, the “engagement points” represent actual constructs having communication channels between a third party and the consumer; via the consumer's smart phone for example. As the consumer transitions from engagement point to another, third parties can be granted the opportunity to publish their content to the consumer, especially if their content contextually matches the consumer's inferred mind state at the engagement point.

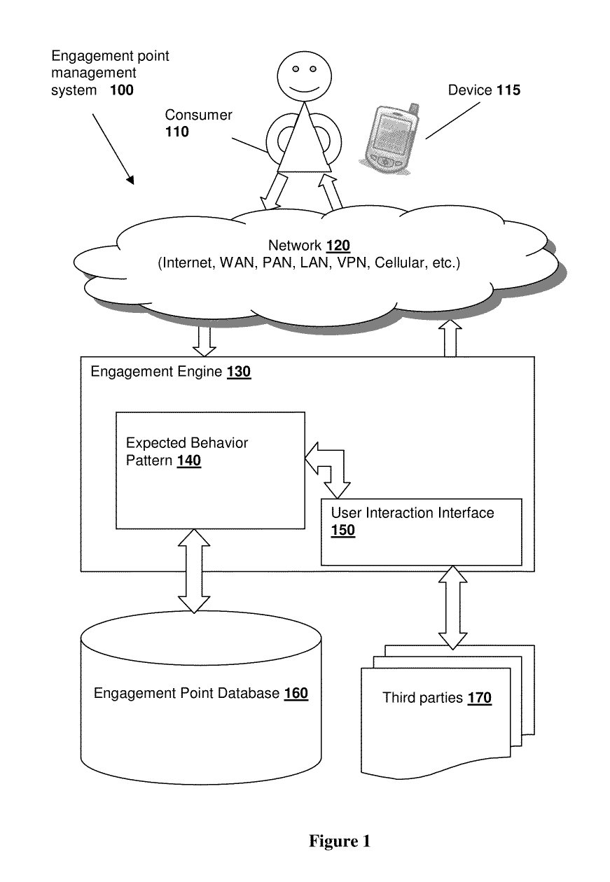

FIG. 1 depicts a general schematic of an engagement point management system 100. The system includes an engagement point database 160 and an engagement engine 130 coupled with the engagement point database 160. Both engagement point database 160 and engagement engine 130 are computing devices having software instructions stored in their respective non-transitory, computer readable memories that cause their respective hardware processor to execute the roles or responsibilities discussed below. One should appreciate that the roles or responsibilities of the various inventive elements can be deployed or distributed across suitably configured computing devices. For example, a device 115 (e.g., a cell phone, a mobile digital device, a kiosk, a GPS, a biometric device, a sensor, a loyalty program service, a healthcare analysis stream management engine, a game device, etc.) could comprise the engagement engine 130 and the engagement point database 160. Alternatively, the device 115 could comprise one or more small applications that configure the device 115 to couple with the engagement engine 130 and the engagement point database 160 over a network 120 (e.g., the Internet, cellular network, WAN, VPN, LAN, Personal area network, WiFi Direct, DLNA, peer-to-peer, ad hoc, mesh, etc.). Further, engagement engine 130 could include a server configured to offer its capabilities as a web service. In some embodiments, engagement engine 130 can be accessed via device 115, or other clients, via one or more web APIs, URLs, URIs, or other network protocols.

The engagement engine 130 can obtain consumer behavior data from device 115 or other devices in the consumer's environment. Consumer behavior data can comprise digital representations of images, sounds, smells, tastes, touch, biometrics, or other data modalities that can be sensed or represented as digital data. The data can also comprise consumers' geographic location, position, orientation data, or additional contextually relevant metadata. The data further could also comprise a consumer's ambient data such as a transaction history, a click-stream history, statistical data, or other data relating to the consumer. Still further, consumers' time data or text data can also be a part of consumer behavior data. Digital representations of consumer behavior data can be captured by one or more sensor devices possibly including a cell phone, a digital camera, a video recording device, a sound recording device, a scanning device, a biometric device, or other sensor platforms.

Once the consumer behavior data is obtained, the engagement engine 130 can derive a context from the consumer behavior data. The context can be considered a data object that describes a consumer's past, present, or future circumstance in relation to the consumer behavior data. The context data structure can include one or more data members having context attribute names and corresponding values. An example data member could include an attribute-value pair of “Location::Los Angeles” that indicates the consumer's location is the city of Los Angeles. A context data structure can be instantiated in real-time on device 115, or other device, based on a digital representation of the environment around device 115. The context data structure can be stored in memory or could be packaged for distribution to other devices over one or more network protocols. In the example shown, device 115 can compile its context data into a serialized format (e.g., XML, JSON, etc.) and send the serialized context data to engagement engine 130, possibly over HTTP or HTTPS.

Consider a scenario where a consumer is walking through an aisle of a grocery store where dairy products are displayed and where image data has been captured indicating the consumer is in the aisle (e.g., cell phone image, security camera, etc.). Engagement engine 130 can derive a context representing that the consumer is shopping (e.g., based on a store address location) for dairy products (e.g., based on images of the products, based on aisle location, etc.), or that the consumer is interested in or has preference upon specific brands of dairy products. In another example, based on a click-stream history of the consumer that shows frequent visits to a vehicle manufacturer website or a dealer website, the engagement engine can derive a context that represents the consumer can be interested in purchasing a vehicle, obtaining a car loan with a low interest rate, receiving ongoing promotions, seeking maintenance, or otherwise being receptive to third party engagement.

The context could comprise a collection of attribute-value pairs. Still, in more sophisticated embodiments, the content can be derived based on one or more context ontologies. For example, based on location information, engagement engine 130 might select a shopping context ontology that indicates possible roles that a consumer might be operating within if the consumer is located in store. Examples of suitable context ontology technologies can include Aspect-Scale-Context (“ASC”), Composite Capabilities/Preference Profile (“CC/PP”), COBRA-ONT, CoDAMoS, CONON, Delivery context, SOUPA, mIO!, etc. The context selected from the shopping ontology could be further refined based on attributes from the digital representation down to: birthday shopping, Christmas shopping, grocery shopping, or other types of shopping. If the consumer's location is outdoors, the context might be selected as “Sports”, “Vacation”, or even “Lost”. At this point, the context is used to provide some level of understanding what behavior the consumer is currently exhibiting. It should be appreciated that the consumer could be exhibiting more than one behavior. Therefore, more than one context could pertain to the consumer, which can further result in engagement engine 130 managing more than instantiated one expected behavior pattern 140.

Based on the context derived from the consumer behavior data, the engagement engine 130 can acquire a set of potential engagement points from the engagement point database 160 that are considered relevant to the context. The engagement points can be considered a collection of data objects that correspond to inferred mind sets that consumer 110 might likely have in their current context. More importantly, each engagement point represents a digital construct through which third parties 170 can publish their content to consumer 110. Thus, the engagement points represent a mapping between an inferred mindset of consumer 110 to a conduit for contextual, personalized content from a third party 170.

An engagement point can include attributes used to associate the engagement point with one or more contexts (e.g. context attributes) and with a corresponding third party (e.g. third party attributes), such that the engagement point can be utilized as a conduit between the third party and a consumer for the exchange of information. In embodiments, the contextual attributes and the third party attributes can be separate attribute sets from different namespaces. In other more preferred embodiments, the contextual attributes and the third party attributes can have some overlap, or can be the same set of attributes.

To associate an engagement point with a context, one or more of the engagement point's context attributes can be matched, mapped, or otherwise associated with context features (e.g., contextual attributes of the context itself or other information associated with the context). For example, an engagement point can be retrieved for a context based on a matching of one or more context attributes of the engagement point with one or more context attributes of the context, can require a particular one or more attribute for the match to be determined, can require attribute values to meet, exceed, fall below or fall within certain value thresholds, etc. Similarly, attributes used to associate an engagement point with a third party can depend on matching of third party attributes of the engagement point with attributes and/or information associated with the third party. In embodiments, relationships between a context and an engagement point and/or an engagement point and a third party can be set a priori. Further, engagement points can be associated with or linked to other engagement points via one or more attributes, which can be sets of attributes from one or more of the context attributes and third party attributes, or a set of specialized linking attributes. Additional examples of the respective association between the engagement points and the contexts, third parties, and other engagement points are discussed in further detail below.

An engagement point can be considered to represent a state of mind of the consumer as the consumer continues forward with his observable activities. Engagement points will be discussed in more detail below. In one embodiment, a set of known engagement points can be a priori bound to a specific context, or context features, and can be transmitted to the engagement engine 130 upon derivation of the context. For example, engagement point database 160 could include numerous engagement point data objects comprising modules or computer executable code reflecting types of engagement points. Each engagement point engagement point database 160 can be indexed according to relevant context attributes; refereeing back to the location example, an engagement point could be tagged with a “Los Angeles” location attribute.

In another embodiment, a set of engagement points that are contextually relevant to the consumer behavior data can be obtained from the engagement point database 160 via search of engagement point database 160 based on context information. A set of engagement points can also be obtained from engagement point database 160 through a query sent by the user or by engagement engine 130 as a function of context. The engagement engine 130 can construct one or more queries as a function of the context, possibly along with any other relevant information (e.g., consumer preferences, biometric status data, etc). The engagement engine 130 can then submit the query to the database 160. In response, the engagement database 160 returns a results set of engagement points that satisfy the criteria of the query.

An engagement point in the present inventive subject matter represents a digital construct instantiated to give rise to opportunities for third parties 170 to engage with consumer 110 based on the consumer's state or activities in which consumer 110 engages. Engagement points can be implemented as executable modules that manage one or more contextual states derived from the digital representation. Thus, the engagement point can be considered a context-based state management engine for states related to a current type of engagement based on the inferred mind set of consumer 110. Each instantiated engagement point can include a communication channel to consumer 110 via device 115 as represented by user interaction interface 150. Examples of an interface could include a TCP/IP session, an HTTP connection, or other type of network connection. Multiple engagement points can be linked together to form an instantiated expected behavior pattern as discussed below.

The engagement points can be considered a nexus of communication between third parties 170 and consumer 110 with respect to the consumer's mindset. The nexus unifies the flow of consumer 110 through their behavior with a consumer's state and further with contextually relevant content. Although engagement points preferably include a communication channel, it should be appreciated that the engagement points comprises greater functionality beyond communication. Engagement engine 130 ensures that each engagement point state and the consumer's context information remain fresh with respect to consumer data. Engagement engine 130 notifies third parties 170 of changes in specific engagement point context so that they can re-tailor their messages appropriately. Further, if the detected changes in the consumer's data are of sufficient magnitude, engagement engine 130 can transition from a currently active engagement point to a different engagement point within expected behavior pattern 140.

The engagement points can correspond to one or more states, possibly including a consumer state, an environment state, a device state, a consumer state of mind, a physical place, or other states. Engagement points can be considered distinct manageable objects through which third parties can electronically engage with consumer 110 via user interaction interface 150. For example, in a context of shopping, a consumer's general interest in purchasing a tablet PC can constitute an engagement point where the “general interest” is considered a state of mind of the consumer. In another example, a consumer's geographical location (e.g., inside a shopping center, nearby a specific aisle of a market, etc.) or environmental circumstances (e.g., expected snowstorm, high temperature, zoning, local news events, fluctuating financial market, etc.) could also represent engagement points. A device state (e.g., vehicle maintenance warning signal, WI-FI for mobile devices, low stock warning for popular items, etc.) can also represent a possible source for an engagement point.

Engagement points can be created, modified or removed by the engagement engine 130 based on various triggers. In some cases the trigger can be based upon a user's input while in other circumstances the trigger can operate without a user's input as a function of the consumer behavior context. For example, if consumer 110 is observed as no longer comparing properties of items and appears to be basing their decision solely on prices of purchasable items, the engagement engine 130 can create an engagement point representing a “price comparison” state of mind within the engagement point database 160 while removing an engagement point representing a “properties comparison” state of mind from a current behavior pattern. Alternatively, both states of mind could remain in an expected behavior pattern depending on the context. The engagement engine 130 can also modify or replace an outdated engagement point with a new engagement points as additional data is observed.

The engagement point database 160 stores and manages engagement points as distinct objects. The engagement point database 160 stores engagement points as individual engagement points, or as a pre-arranged group of engagement points. For example, the engagement point database 160 can store engagement points individually that reflect “interest in purchasing a new vehicle”, “searching a new model of vehicle”, “interest in obtaining a car loan”, or other types of engagement points. Each of these types of engagement points can include circumstance-specific information that facilitates engagement with consumer 110. Consider a case where consumer 110 is interested in finding a health care provider. A corresponding engagement point of “Evaluating Health Care Providers” could include digital medical history forms to be filled out by consumer 110 or even automatically filled out by engagement engine 130 based on context information (e.g., user name, address, etc.).

Further, the engagement point database 160 store arrangements of engagement points in a group of “vehicle purchase related engagement points”, and store them as a group according to a desirable schema. Upon changes of engagement points status including addition, deletion, or modification, the engagement point database 160 can store such status changes. One should appreciate that each engagement point or group of engagement points could be indexed by one or more context properties (e.g. time, locations, user identity, state information, behavior pattern information, object recognition parameters, etc.). Each dimension of the indexing schema could be represented through various techniques including hash tables, hash values, addresses, nearest neighbors (e.g., kNN, spill trees, kd trees, etc.). Example techniques for recognizing a context or object that can be suitably adapted for use with the inventive subject matter include those discussed in co-owned U.S. Pat. Nos. 7,016,532; 7,680,324; 7,565,008; and 7,899,252, and their daughter applications.

Once a set of engagement points are obtained from the engagement point database 160, the engagement engine 130 can link the engagement points together according to a behavior rule set to instantiate an expected behavior pattern 140 of consumer 110. It should be appreciated that engagement engine 130 hosts or otherwise manages expected behavior pattern 140. One can consider expected behavior pattern 140 as a flow of connected activities or states through which the consumer is expected to pass or flow as they continue toward their objectives. In one embodiment, the behavior rule set comprises a priori generated rule sets. In such embodiments, one or more a priori generated rule sets are stored in the engagement point database 160, and a user can retrieve or review one or more of those rule sets from the engagement point database 160 and select one of them. Such a priori generated rule sets can be stored in engagement engine 130, and a user can select and apply one of the rule sets without a step of retrieving the rule set from the engagement point database 160. In another embodiment, engagement engine 130 can construct the behavior rule set as a function of the context. In this embodiment, engagement engine 130 can construct the behavior rule set in a substantially real-time upon receiving the consumer behavior, preferably with little latency (e.g. less than 100 ms) so that the expected behavior pattern 140 of consumer 110 can reflect the most recent state of the consumer behavior.

As an example, consider a “Shopping” context. A behavior rule set might include generic “Shopping” rules that govern arrangement of engagement points according to expected behavior pattern 140 that represents Shopping. Still, additional behavior rules sets might include finer grained rules that focus on a particular type of Shopping; Christmas Shopping for example. It should be appreciated that both rules sets could be applicable. The Shopping rules set might indicate the ordering or connections among the engagement points while the Christmas Shopping rules set could include instructions or command by which engagement engine 130 transitions consumer 110 from point to point.

In some embodiments, engagement point management system 100 can include one or more management interface (e.g., HTTP server, application, etc.) through which various stakeholders such as third parties 170 are able to define constructs such behavior rules sets. For example, an advertiser could create a behavior rules set via which they would preferred to see engagement points linked into expected behavior pattern 140. Each rules set can include instructions or conditions by which engagement engine 130 transitions consumer 110 from one engagement point to another as a function of the consumer data, and hence consumer context. Interestingly, each behavior rules set could be considered a valuable property to the owner. If the rules set generates an effective or profitable behavior pattern, the owner could offer the behavior rules sets to others for a fee (e.g., license fee, sale fee, auction prices, etc.).

In consumer expected behavior pattern 140, each linked engagement point can be assigned a contextual engagement point signature that allows for matching the consumer's engagement point with the interests of third party content providers represented by third party 170. Each consumer can have different contextual engagement point signature in an engagement point. For example, consumer A and consumer B might enter the same store where their individual expected behavior patterns 140 might have the same type of engagement point, “Browsing” for example. However, based on A and B's different product interests, A's engagement point signature might be different from B's, perhaps A's engagement point signature is based on being in the Asian food section in the store, while B's engagement point signature is based on being in the beer section in the store. Thus, the satisfaction of the contextual engagement point signature can be determined by mapping engagement point attributes or contextual information to advertiser content attributes (i.e. A's engagement point signature is comparing prices between similar items in Asian food section in the store, and the advertiser advertises items in Asian food sold at the store.). In this example, both A and B are browsing through their respective aisles and consumer A would receive content from a third party 170 wishing to advertise Asian food while consumer B would receive content from a third party wishing to advertise beer even though both consumers A and B are considered to be in an engagement point “Browsing”. The reader should appreciate that each of consumer A and B could have their own instance of the “Browsing” engagement point, or could share the same instance while their personalized information differentiates their contextual engagement signatures. Alternatively, engagement engine 130 could instantiate a single instance of the “Browsing” engagement point that services multiple consumers, perhaps based on demographic profile. Both approaches have advantages. A single engagement point instance per consumer provides third parties 170 an opportunity to provide highly personalized content. A shared engagement point instance for a group would be less resource intensive on engagement engine 130.

Engagement engine 130 is further configured to create a data channel between one or more content providers and the consumer and by providing the content providers with user interaction interface 150 to the engagement point construct through a network 120 (e.g. an API, a PaaS, IaaS, or SaaS service, a remote procedure call, FTP, SMS, SMTP, HTTP, etc.). The user interaction interface 150 can comprise a direct mail, a letter, a website, an email, a kiosk portal, a text message via cellular phone, a consumer service, a mobile device application, or other channel. In more preferred embodiments, interaction interface 150 can be deployed in other types of engines. For example, in a context of shopping, the instantiated engagement point engine can comprise engines corresponding to each engagement point such as product comparison engine, decision engine, payment engine, search engine, social networking engine (e.g., Facebook, etc.), or other type of engine depending on the nature of expected behavior pattern 140 or the actual type of engagement point.

In the example shown, engagement engine 130 hosts a single instance of expected behavior pattern 140. It should be appreciated that each individual engagement point could operate individually within its own engine, referred to as an “engagement point engine”. For example, each instantiated engagement point engine could comprise a virtual machine on which an individual engagement point executes. Each engagement point engine can be configured to maintain communication connections (e.g., TCP/IP session, UDP/IP packets, etc.) to other engagement points, if necessary, in the expected behavior pattern 140 according to the behavior rules set. Still, one should appreciate that such engagement point engines are not limited to the context of shopping. As such, consumer's expected behavior pattern could comprise contexts of sports, gaming, travel, continuum of care, learning ecosystems, medical service, patient healthcare, education, life stage, finances, or other types of behaviors or activities. Thus, engagement point engine can comprise many different types of engines according to the types of behavior pattern engaged by the consumer.

Upon satisfaction of the contextual engagement point signature of a linked engagement point, the engine can allow a third party 170 (e.g. marketers, advertisers, service providers, sellers, publisher, brand managers, etc.) to submit content to the consumer via the user interaction interface 150 coupled with to the engagement points. For example, when the consumer compares similar models of tablet PCs in several on-line retail stores, the engagement engine 130 can allow on-line marketers of on-line retail stores to access to the consumer through the mobile device application, pop-up windows, or emails to provide information of deals, promotions, discount coupons, or other actionable information.

The engagement engine 130 can further allow third parties 170 to engage with consumers through a consumer's second screen. Consider a scenario where a consumer is browsing for audio speakers via a web browser on their laptop computer. While the consumer is engaged with a first screen (i.e., the browser), third party content provider could engage with the consumer via the consumer's smart phone or television (i.e., a second screen) by sending complementary content for display. Thus, in this case, engagement engine 130 can provide the consumer an opportunity to engage in multiple experiences through the multiple screens in one or more engagement points. In this example, user interaction interface 150 does not necessarily have to reside on the same computing device that manages or maintains expected behavior pattern 140. In other embodiments, engagement engine 130 operates as a central communication hub through which content from third parties 170 is routed to consumer 110. Thus third parties 170 can indirectly or directly connect with consumer 110 depending on the nature of user interaction interface 150.

The engagement engine 130 can allow third party 170 to use the user interaction interface 150 as a publishing platform to publish its own content (e.g., self generated messaging content) to the engagement points within expected behavior 140. For example, a brand manager can create content comprising brand images, product information, daily promotions, or other content on a daily basis and publish such content as self-generated messaging toward the consumer's social network webpage or application on mobile devices. As consumer 110 flows through their expected behavior pattern 140, content provided by third party 170 can be shared with other potential consumers through the consumers' social network, emails, or other communication tools. Thus, in this case, a brand manager can be both an advertiser and a publisher, while user interaction interface 150 operates as an interface to social media networks (e.g., Facebook®, Pinterest®, Instagram®, etc.).

Engagement engine 130 can further provide third party 170 a path to influence or nudge the consumer 110 or other potential consumers to other engagement points or even to a new expected behaviors patterns 140 by allowing to third party 170 to leverage user interaction interface 150 as a publishing platform (e.g., going to particular retailer stores, browsing new products, etc.). From this perspective, one should appreciate that brand manager can influence consumer's behavior pattern. For example, by publishing content of a new product promotion at a particular retail store on the consumer's social network page or social network application, the brand manager can nudge the consumer to a particular store to purchase the product. Furthermore, by sharing the promotional information via the social network, the brand manager can lead new consumers to enter the new engagement point of interest in the product or browsing products. This approach allows the third party 170 to influence, perhaps subtly, the actual behavior of consumer 110 to better align with expected behavior pattern 140, specific engagement points, or even completely new expected behavior patterns. Further, this approach also provide for a very strong alignment between a third party's call to action and a mindset of consumer 110 that would be most amenable to accept the call to action.

Interestingly, system 100 provides an empirical test bed to validate applicability of calls to action. Engagement engine 130 has an understanding of an inferred state of mind of an engagement point as determined from consumer context data in the form of attributes. The call to action also has attributes, preferably in the same namespace as the consumer's engagement point context data. Though observation of many of consumer 110 rising to the call to action, or not rising to the call, an analysis engine can validate correlations between the consumer's mind set and the call to action. The evaluation of the correlations can be conducted using multivariate analysis. The results of the multivariate analysis can then be used within a ranking scheme to determine which content is most appropriate given the engagement point's context. For example, the results of the multivariate analysis can be used as input to a Ranking Support Vector Machine (SVM). The resulting retrieval function with its weights can be used to better select which content from one or more third parties 170 would be matches for consumer 110.

Engagement engine 130 can further predict appropriate timing for submitting content (e.g., promotion, advertisement, product information, etc.) based on consumer behavior pattern 140, and provide the prediction to the third party. For example, the consumer could be at the engagement point representing comparing new tablet PC models. Based the consumer behavior pattern 140, engagement engine 130 can predict that the consumer is likely to move to the next engagement point (e.g. comparing prices among retailers) in 6 hours based on historical information. Engagement engine 130 can provide the prediction to tablet PC retailers so that retailers can create or submit their content within 6 hours to the next engagement point (e.g., upcoming promotions, financing options, etc.). In such cases engagement engine 130 can provide notifications to third party 170 about expected future behaviors. Confidence scores can also be provided based on past observations of similar consumers shift form a similar engagement point to the next engagement point. The confidence scores allow third parties 170 to refine their message. For example if the confidence score is low, then the message could take on a more generic tone. If the confidence score is high, then the message can be more specifically tailored to the current situation.

The engagement points, individually or as a group of engagement points within a consumer behavior pattern, can be sold, purchased, leased, or subject to a pay per use contract. In one embodiment, the engagement point management system 100 further comprises an engagement point purchasing server. The purchasing server can be configured to accept fees from third parties (e.g. marketers, advertisers, auction winners, service providers, sellers, etc.) with respect to accessing consumers through the engagement points within the behavior pattern. Such fees can include a pay per use charge, a fee from an auction result, a subscription fee, or a flat fee. The fee can be adjusted based on the demands by the third parties. A higher fee can be accounted for an exclusive use by a third party 170.

While the discussion above is focused on the example of shopping, one should appreciate that expected behavior pattern 140 can represent behaviors beyond shopping. Depending on the nature of the behavior, corresponding engagement points could include sports engagement points, gaming engagement points, travel engagement points, continuum of care engagement points, medical service engagement points, patient healthcare engagement points, education engagement points, life stage engagement points, and financial engagement points. Furthermore, one should appreciate that the types of engagement point sets are not limited, yet can be derived from any events a person can be engaged during one's life. It should be also appreciated that the number and types of engagement points for a type of behavior can be modified by a user or by the engagement engine so that sets of engagement points stored in the engagement database can be updated with any circumstantial changes of the consumer.

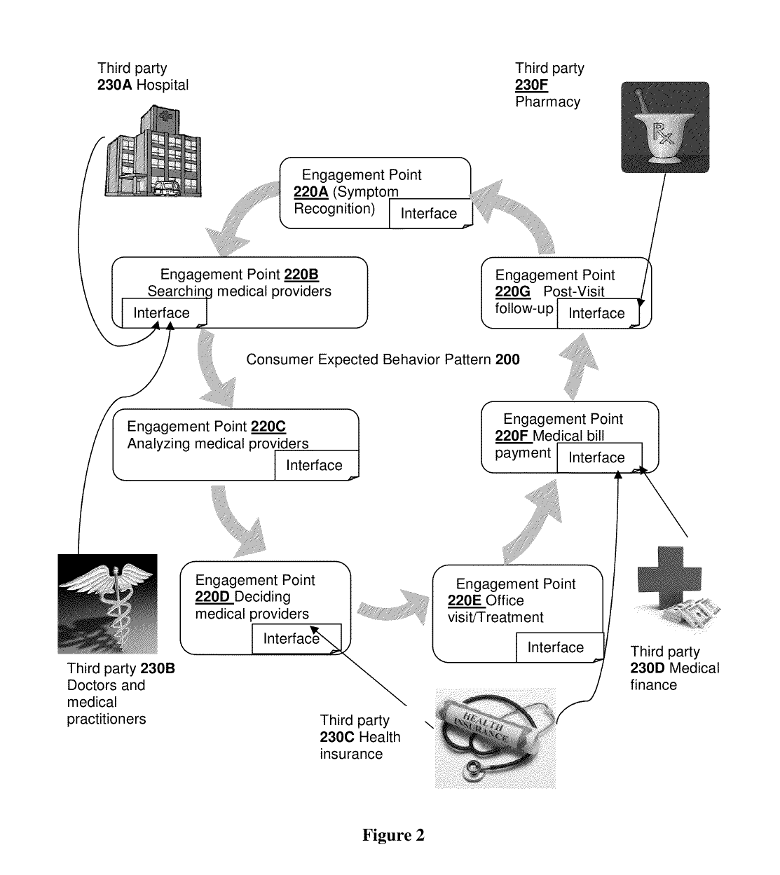

FIG. 2 depicts an exemplary schematic of consumer expected behavior pattern 200 in a context of medical services to illustrate the breadth of the inventive subject matter across many markets beyond shopping or omni-channel marketing. In this example, a consumer's expected behavior pattern comprises seven engagement points, 220A-G, each of which can be considered to correspond to the consumer's state-of-mind, physical status or environmental status. Such engagement points can be a pre-arranged group of engagement points through which a person is likely to pass as they engage with medical services. However, those engagement points can be also selected individually by the engagement engine to create a custom consumer expected behavior pattern 200 based on the consumer's previous behavior data of accessing, receiving or paying for medical services.

In the example shown, expected behavior pattern 200 forms a circular chain of seven engagement points 220. Still, it should be appreciated that expected behavior pattern 200 could comprise any practical number of engagement points 220. The number and arrangement can be dictated by one or more contextually relevant behavior rules sets as discussed previously. It should be further appreciated that expected behavior pattern 200 could include other arrangements beyond a circular arrangement. For example, expected behavior pattern 200 could include a tree structure, hierarchal structure, a linear chain, combinations of multiple arrangements, or other structure.

As an example, consider an expected behavior that corresponds to physical therapy session. The session might be represented as a linear chain having a clear beginning and a clear end that is expected to last one hour. The engagement points could represent the following: Arrival, Warm-up, Therapy, Cool-down, New Appointment, and Leave. At each engagement point of the “Physical Therapy” expected behavior pattern; the patient can be provided content. During arrival, the facility can present forms that could be filled out electronically. During the warm-up engagement point, the patient can be supplied content, music for example, that increases with tempo until their warm-up is complete. During therapy, the patient can be provided personalized encouragement; some people respond to positive encouragement while others respond to challenges. While cooling down, the patient could be engaged with soothing music or decreasing tempo music. As the patient is transitioned to the new appointment engagement point, the patient could be presented with a calendar of options. Finally, as the patient enters the leaving engagement point, the patient could be presented a bill, insurance claim, or other commercial transaction data to pay for the session.

Note that each of engagement points 220 includes an interface. The interface represents a portal or channel through which a third party can submit content to the patient. The patient's smart phone could operate as one end point of the channel for example. One should appreciate that engagement points 220 could represent fully instantiated virtual machines or other types of suitably configured computing devices operating in a client—server architecture where the interface could be a server port, HTTP TCP port 80 for example. As one or more of third party 230 provide content to an engagement point 220 via its interface, the virtual machine or device operating as engagement point 220 forwards the communication to the consumer's device.

In this example, an engagement engine observes a consumer entering expected behavior pattern 200 based on the consumer's contextual attributes matching the context attributes of at least one of engagement points 220. In this case, the consumers enters the engagement point 220A representing “symptom recognition” perhaps because the consumer is alarmed by her abnormal physical symptom perhaps as expressed on a social media web site, in an email, through browser history, or other observable source. The consumer can also enter the engagement point 220A of symptom recognition when the consumer notices a nearing of a regular check-up time. Once the consumer recognizes the symptom perhaps through object recognition techniques (e.g., captures an image of a melanoma, etc.), the consumer transitions to the second engagement point 220B of “searching for medical providers” capable of addressing the symptom. Then, the consumer migrates to the engagement point 220C to make a “comparison among medical providers” found from the search results. After such analysis, the consumer enters the engagement point 220D representing a decision point relating to engaging medical providers. Following the decision, the consumer would be expected to enter the engagement point 220E representing an office visit. Upon finishing a doctor's treatment, the consumer enters the engagement point 220F for representing “medical bill payment”. Further, the consumer engages in the engagement point 220G for post-visit follow up including purchasing prescription drugs. If the doctor's treatment was not effective enough, the consumer might enter back to the engagement point 220A and repeat the behavior pattern 200. The corresponding behavior rules set configures expected behavior pattern 200 with migration or transition conditions as the consumer takes various actions. One should appreciate that expected behavior pattern 200 represents one possible example presented for illustrative purposes. All possible expected behavior patterns are contemplated.

Each engagement point 220 can also comprise include information relating to the amount of time expected to be spent at the point. In some cases, the expected duration could be very short, perhaps just a few second. In such a case, third parties 230 can be provided window of opportunity to inject their personalized content to the consumer. Still, the duration for an engagement point 220 could be minutes, hours, days, weeks, or even years.

For each engagement point 220 of consumer expected behavior pattern 240 representing the context of a patient making decisions with respect to obtaining medical services, the engagement engine provides a user interaction interface available to third parties 230A-F to provide personalized content to the patient or consumer. For example, when the consumer is found to be in the engagement point 220B related to searching for medical providers, the contextual engagement point signature of the consumer (e.g., searching for a clinic to treat the consumer's skin rashes) could meet the contextual requirements of content of one or more third parties, a hospital 230A and individual doctors and medical practitioners 230B for example. Upon satisfaction of contextual matching criteria, the hospital 230A and the doctors 230B could be allowed to submit content including information on the consumer's condition, perhaps information on various skin rashes and dermatologists specialize in skin rashes, to the engagement engine using a user interaction interface, which would be transmitted to the consumer through the network (e.g., the Internet, cellular network, WAN, VPN, LAN, etc.) to the consumer's device. The approach provides two distinct advantages. First, engagement points 220 provide increased certainty on the consumer mind set with respect to their behavior and their current activities. Second, third parties are able to accurately map their messages to the consumer's mind set while also ensuring their message relates directly to the consumer's context.

Likewise, another third party, health insurance provider 230C, could be allowed to submit its content to the consumer's engagements points 220D, 220F, where the consumer considers a health insurance coverage as a factor in making a decision of medical providers, and where the consumer contemplates a method of medical bill payments, respectively. Similarly, the engagement engine can allow another third party 230D, medical financing provider, to submit content to the engagement point 220F, when one of consumer's engagement signature points in the engagement point 220F is searching for a financing to pay medical bills. As another example, in the engagement point 220G, where the consumer engages in post-visit follow up, the engagement engine can allow another third party 230F, pharmacy, to provide personalized content, such as substitutable discounted generic drug or ongoing promotions by the consumer's nearby pharmacies.

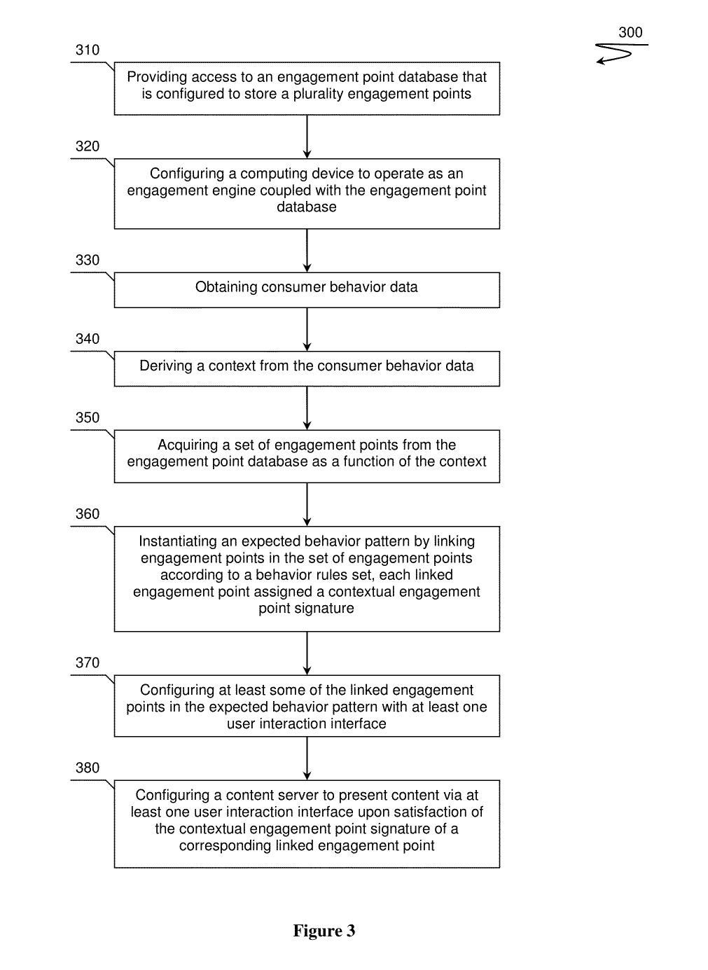

FIG. 3 illustrates method 300 of providing a personalized consumer engagement experience. Method 300 indicates how engagement engines can determine a mindset of a consumer and instantiate a conduit of communication between a content provider and the consumer. Such conduits can include unidirectional communication channels, bi-directional communication channels, or even multi-party communication channels (e.g., social network interfaces, etc.). The content can provide can submit highly contextually relevant content to the consumer via the conduit.

Step 310 comprises providing access to an engagement point database where the engagement point database is configured to store a plurality engagement points. The engagement point database could be deployed locally on a consumer's device (e.g., smart phone, tablet, Google Glass, etc.) in local memory. Still, the engagement point database can also be deployed over a network, possibly at a remote location. For example, the engagement point database could be hosted on one or more remote servers or cloud-based systems (e.g., A9, Azure, etc.). Engagement points within the engagement point database can be indexed by context information (e.g., attributes, context identifiers, etc.) indicating to which contexts the engagement points are relevant.

Access to the engagement point database can be gained by one or more engagement engines through various techniques. When the database is deployed on a consumer's device, access could already be granted; still some authentication might be required depending on the actual implementation. In some cases where engagement point database is remotely accessible over a network, access can be gained through proper authentication techniques (e.g., password, Radius, KERBEROS, etc.). Still further, access could be gain based on a consumer's context attributes. As an example, consider an ecosystem that manages inventory. As end users enter a store's location (e.g., GPS, geo-fenced area, etc.) or even a specific aisle (e.g., WiFi signal triangulation, received signal strength, etc.), the users can be granted access to appropriate databases or portions of databases having inventory information for the store.

Step 320 includes configuring a computing device to operate as an engagement engine where the engagement engine couples with the engagement point database. In highly personalized embodiments, a consumer's personal device such as their smart phone, smart watch, phablet, tablet, personal computer, appliances, or other device can install one or more apps that fulfill roles or responsibilities associated with engagement engines a discussed above. Such apps can access the engagement point database from a local data store (e.g., memory, disk drive, etc.), or over network. Yet in other embodiments, the computing device could be a server configured with software applications that allow the server to offer its engagement point services over the Internet, possibly via one or more web service API protocols (e.g., SOAP, WSDL, HTTP, etc.).

The computing device could be configured with a single instance of the engagement engine or could be configured with multiple instances of the engagement engine. First consider a consumer's smart phone. The smart phone could be provisioned with an app that represents the engagement engine. The single instance can instantiate multiple expected behavior patterns depending on the nature of the consumer's contexts, at least to the limits of the limited memory available. Each of these expected behavior patterns could be implemented as an independent thread or state machine. Second, consider a service-based implementation made available over the Internet. A sever could create multiple instances of the engagement engine, perhaps each within a separate, isolated virtual machine. Each instance could be dedicated to a specific individual, or could be dedicated to groups of individuals sharing a common contextual experience (e.g., enterprise work-flow, a sporting event, a social media event, shopping, etc.).

Step 330 included the engagement engine obtaining consumer behavior data, preferably in the form of the user's environment. The consumer behavior data could include images of the consumer, images of their environment, audio data relating to the consumer's discussions or emotions, biometric data that might indicate stress levels or health conditions, or other data modalities. Each of the types of behavior data could be in a raw format, but can be converted to one or more measures of the consumer's behavior. For example, a smart phone's accelerometery and GPS data could be converted into position, orientation, or heading information. The measures can take on the form of attributes and values as discussed previously; time, temperature, heading, location, heart rate, blood pressure, actions, etc. just to name a few.

At step 340 the engagement engine derives one or more contexts from the consumer behavior data. The consumer's contexts can be derived by distilling the behavior data down into a set of attributes and corresponding values. These attribute-value pairs could be implemented as an N-tuple or a vector in the memory of the engagement engine. In some embodiment, the engagement engine can have access to a set of a priori defined consumer contexts, perhaps named according to a defined ontology. Each defined consumer context could be tagged with required attributes or optional attributes, or could have a context identifier (e.g., GUID, UUID, name, etc.). The attribute-value pairs from the consumer behavior data can be used to select which contexts are most related to this consumer's current behavior based on matching the pairs with tagged attributes of the known consumer's contexts. It should be appreciated that the consumer's context could represent a past context, present or even real-time context, or a future predicated context.

Step 350 includes the engagement engine acquiring a set of engagement points from the engagement point database as a function of the consumer's content. The engagement points could be acquired by submitting a query to the engagement point database where the query is constructed according to the indexing schema of the database. For example, in embodiments where the engagement points are indexed by attribute-value pairs, the database can could return engagement points tagged with matching or similar (i.e., near neighbors) attribute value-pairs. Alternatively, the query could comprise one or more defined consumer context identifiers, which would cause the engagement point database to return a result set having engagement point objects that have been indexed by or tagged with the context identifiers. It should be appreciated that engagement point database could return a set of engagement point objects as distinct data object, a list of engagement point objects, or a set of references or pointers to engagement point objects. Each engagement point object could be considered a state in a state machine.

At step 360 the engagement engine instantiates an expected behavior pattern by linking at least some of the engagement points together according to one or more behavior rules sets. In the case where each engagement point could be considered a state that reflects a consumer's mindset, the expected behavior pattern could be implanted as a state machine where transitions from one state to other depend on observed updates to the consumer behavior data. The transitions from state-to-state can also be governed by the behavior rules sets. In other embodiments, each engagement point could be implemented as its own thread or process. When the engagement point is active, the corresponding process can be activated (e.g., made to run, execute, etc.). If the consumer is not considered to be within an engagement point, then its corresponding processes can be deactivated (e.g., sleep, hibernate, etc.). All the threads could execute on data stored in a common, shared memory storing consumer state information.

The behavior rules sets can be obtained through various techniques. The rules sets could be a priori bound to the engagement engine and already be present in the engine's code. Such an approach is advantageous when the engine is part of an application specific setting, “Shopping” for example. In such a case, a single type of shopping behavior rules set would likely be sufficient across multiple users. Still, in other more sophisticated embodiments behavior rules sets could also be stored in a rules database from which rules can be obtained. This approach provides for greater variation in rules sets and provides for broad coverage across consumer's behaviors. Still further, the behavior rules sets could be highly personalized to the consumer or the rules set creator. In such a case, the rules could include details with respect to user preferences that color the user's specific transition from state to state. Further, such rules could also include specific details with respect to how a content provider expects the user to transition from state to state. For example, store owner might use aisle location as a trigger point to influence a transition from one engagement point to another.

The behavior rules set could configure the expected behavior pattern into a number of different arrangements. Some arrangements might be exist only for very short periods of time; minutes or seconds, perhaps related to rapid response situations or military training exercises. Other arrangements might exist for extended periods of times; days, weeks, months, or even years. For example, an expected behavior pattern could represent the education of a student over years. Each of the engagement points might correspond to a lesson and content provided by a third party might include lesson materials that are tailored to the student's mindset. Further the arrangements of the engagement points within the instantiated expected behavior pattern could comprises a chained circle (see FIG. 2), a linear chain, a tree structure, hierarchical structures, multi-connected graphs, directed graphs, acyclic graphs, or other forms. For repetitive behaviors (e.g., shopping, training, exercise, work-flows etc.), a circular chain could be used, perhaps where one the engagement points represents an idle mindset between an end state and start of a new cycle.

Each of the engagement points also incorporates a contextual engagement point signature that can be defined, again, based on attributes. The signature indicates the current context of the engagement point as it relates to the inferred mindset of the consumer. The signature could be represented as a static structure that specifically relates the instantiated engagement point and its corresponding consumer mindset. For example, if the engagement point represents “Browsing” within a shopping context, the contextual engagement point signature might be defined with specific browsing information associated with the shopper; specific product names, browsing locations, specific brands, a browsing identifier, or other information. In other cases, the signature could be dynamic in the sense that is reflects slight shifts in the mindset of the consumer while still falling within the bounds or constraints of the engagement point. Returning to the browsing example, the signature might include additional information, perhaps including consumer heart rate or breath rate, a change in shopping aisle location, or other engagement point context data that could change with time.

Step 370 comprises the engagement point configuring at least some of the engagement points in the expected behavior patterns with user interaction interfaces. The user interaction interfaces are instantiate communication channels between a user device and a third party. The communication channel could take the form of one or more network protocols: TCP/IP, SMS, MMS, UDP/IP, HTTP, RSS, ATOM, or other protocols. Further, the communication protocol could also be application-specific or proprietary. The communication protocol could be uni-directional where only content from the third party flows to the user or the user's device, bi-directional or interactive where the user is able to interact with the third party's content (e.g., games, chat, phone calls, etc.), or even multi-party channels (e.g., a chat room, video group chat, etc.). Of specific import, the user interaction interfaces provides the third party an opportunity o engage the consumer directly when the consumer enters a known or expected mindset. The user interaction interface could be located directly on the user's device or could be located on a server, which mediates communication between the third party and the user. Such an approach is considered useful to aid in preserving user privacy.

Step 380 includes the engagement engine configuring a content server to present content via the user interaction interface upon satisfaction of the contextual engagement point signature. The engagement engine can notify registered third party content servers that an engagement point is active and provide the engagement point's contextual signature to the content servers. In response, the content servers can identify which of their pieces of content have attributes that satisfy the conditions or requires of the signature. If approved by the engagement engine, or more specifically by the engagement point, the content can be forwarded to the user via the user interaction interface.

In some embodiments, the engagement point itself can compare the content's attributes to its own signature and rank the content according to similarity to the contextual engagement point signature. The engagement point can then select which of the matches to forward on to the user based on the rankings. The rankings could be based on Hamming distances, SVM classifications, or other similarity measuring techniques.

It should be appreciated that the configuration of the content server can include a bi-directional communication between the engagement engine or the engagement point and the content server. For example, the engagement point can submit the contextual engagement point signature to the content server, perhaps in form of an XML encoding the signatures vector, N-Tuple, or other structure representing the attributes of the signature. The content server can then submit content back to the engagement point for review or analysis. Alternatively, the content server can modify, or personalize, its content to better conform to the signature requirements. For example, the content could be updated with images of the user or include content representing a user preference with respect to a current mindset. Such negotiations can be conducted with multiple content servers as the same time. This gives rise to a value proposition where the content servers can bid for or enhance their content offerings to increase their ranking, assuming at least a base-line match with the signature. Once negotiations are complete, the engagement point can forward on the “winning” content to the user.

The management of consumer expected behavior patterns can be also applied to other arenas beyond medical services or shopping. Consider sports. For example, the engagement engine can construct and manage a consumer expected behavior pattern for a baseball fan, who often goes to a stadium to watch a baseball game. The engagement engine can obtain the fan's behavior data from various sensor devices including baseball game or baseball players images stored in the fan's cell phone or computer, a click-stream history of the fan such as frequent visits to Major League Baseball (MLB) homepage or ESPN.com, the engagement engine can derive a context that the fan would be interested in going to a MLB baseball game in coming weekend.

Based on such context derived from the fan's behavior data, the engagement engine can acquire a set of engagement points related to “going to a baseball game.” Such a set of engagement points can include engagement points of interest in a weekend baseball game, searching game schedules, searching available game tickets, purchasing game tickets, going to baseball stadium, revisiting the game. These engagement points can be selected as a pre-arranged group forming a behavior pattern named “going to a baseball game” or can be individually selected from the engagement point database. In some cases, the engagement engine can construct one or more queries as a function of the context “going to a baseball game”, possibly along with any other relevant information (e.g., the fan's favorite teams, weather forecast on the game day, etc.). The engagement engine can then submit the query to the database. In response, the engagement database returns a results set of engagement points that satisfy the criteria of the query. These engagement points can also be modified or removed from the engagement point database, or can be created when the fan engages in new behavior in the same context.

The set of engagement points acquired from the engagement point database are arranged to construct the fan's expected behavior pattern in “going to a baseball game.” In arranging engagement points in a specific order, the engagement engine can utilize behavior rule set, possibly including a priori generated rule sets. For example, if one of a priori generated rules is that the fan purchases a game ticket before he arrives at the baseball stadium, then the engagement point of purchasing ticket should precede the engagement point of going to the stadium. However, it should be noted that such rules can be created by the engagement engine in a substantially real-time upon receiving the consumer behavior data.

Once the fan's expected behavior pattern is constructed, the engagement engine can create channels to the third parties to access to the fan's engagement points via a user interaction interface, which further comprises an engagement point engine corresponding to each engagement point. For example, “purchasing game tickets” engagement point can be accessed via a user interaction interface comprising “purchasing game tickets” engagement engine. When the fan enters the engagement point and satisfy the context of engagement point signature, third parties can submit personalized content to the engagement point via a user interaction interface. For example, the fan selects the date and location of the baseball game, which satisfies the context of engagement point signature, then ticket venders can submit discounted ticket information, parking service providers can submit parking price on the game day and offer a discounted package of parking and game tickets to “purchasing game tickets” engagement point via a user interaction interface. After the game, when the fan turns on his computer to access to post-game information, the “revisiting the game” engagement engine can allow a content provider to submit a content of “slow-motion clip videos of today's play” to the “revisiting the game” engagement point.

The management of consumer expected behavior pattern can be also applied to the context of multi-channel marketing. In this scenario, the engagement engine can construct a consumer expected behavior pattern with shopping related engagement points acquired from the engagement point database (e.g. interest in a new shopping item, searching different models of the item, comparing among models and manufacturers, comparing prices among sellers, making a decision to purchase, payment, post-purchase follow-up, etc.). Upon changes of consumer behavior, the engagement engine can update the consumer behavior pattern by creating, modifying or removing engagement points. For each engagement point, the engagement engine enables third parties to submit content to the engagement point via a user interaction interface. For example, for the engagement point of comparing among models and manufacturers, advertisers from various manufacturing companies can submit advertising information of their products including warranty information to the engagement point. In another example, for the engagement point of payment, advertisers from credit card companies can submit information of reward program, lower interest for specific purchases, or payment plans. The management of consumer expected behavior pattern in a context of multi-channel marketing is especially beneficial by providing tools for continuum of marketing based on consumer's positive shopping experience.

The management of consumer expected behavior pattern can be also applied to the context of gaming, video gaming for example. In this scenario, the engagement engine can construct a consumer expected behavior pattern with gaming related engagement points (e.g. beginning a new game, obtaining a new game item, advancing game steps, etc.). For each engagement point, the engagement engine can allow third parties to provide personalized content via a user interaction interface (e.g. gaming items purchase information, information of step advancement, interaction with other users, recommendation for a new game, etc.). In some instances, the engagement engine also can allow third parties to provide a gamer free game content along with advertisements.

The management of consumer expected behavior pattern can be also applied to the context of travel. In this scenario, the engagement engine can construct a consumer expected behavior pattern with travel related engagement points (e.g. searching for a place for honeymoon, searching for a travel package or individual airline tickets and hotel reservations, searching for outdoor activities, comparing and purchasing traveler's insurance, after travel organization, etc.). For each engagement point, the engagement engine can allow third parties to provide personalized content via a user interaction interface (e.g. discount information for travel package, information for travelers insurance, advertisement for photograph assembly, travel reward program, etc.).

The management of consumer expected behavior pattern can be also applied to the context of an enterprise. In this scenario, the engagement engine can construct a consumer expected behavior pattern with work-flow related engagement point. For example, in a construction site, the expected behavior pattern can include one or more engagement points of checking the current status of construction, discovery of next project, checking available workers or groups of workers for the project, distribution of the project among workers, checking individual accomplishments in the project, etc.). For each engagement point, the engagement engine can allow other groups of workers or third parties to provide inputs or feedbacks via a user interaction interface (e.g. unexpected shortage in building components, unexpected delay in other projects, etc.). In some instances, the engagement engine can reconstruct the expected behavior pattern upon receiving inputs or feedbacks from third parties.

Yet another interesting aspect of the inventive subject matter includes the capabilities of providing oversight or insight into health care activities. Engagement engines can construct expected behavior patterns not only for patients, but for all health care stakeholders (e.g., insurance providers, care providers, doctors, nurses, surgeons, technicians, etc.). Each stakeholder could have one or more active expected behavior patterns that can then intersect with other stakeholder's expected behavior patterns. The disclosed engagement engines can be further configured to monitor how each stakeholder adheres to expected patterns (e.g., best practices) or interacts with others (e.g., quality of care). Further and more interesting, the engagement engine can provide insight or discover potential improvements to a context. For example, should a stakeholder deviate from an expected behavior pattern yet generate a better result from the behavior (e.g., better alignment with others, higher survival rates, etc.), the engagement engine can update known behavior patterns with new engagement points representing a best practice. It should be appreciated that the context information in health care could be quite fine grained, from medical history, test results, down to genomic (e.g., genes, protein expressions, pathways, etc.) information. All of these factors could influence engagement point contexts. Thus, the disclosed ecosystem can exist within a health care oversight platform, which yields true evidence-based medicine based on actual observations of patients. Example evidence could include actual observed behaviors relative to expectations after receiving treatment. Such evidence could be considered as being collected over a continuous longitudinal study, possibly across large population segments.

Still another example use-case of how the disclose engagement point management systems can be leveraged includes inventory management or supply chain management. In such scenarios an expected behavior pattern can be instantiated to represent numerous aspects of inventory management from the vendor's perspective, from the consumer's perspective, retailer's perspective, from the supplier's perspective, or other facet.

With respect to a consumer, the expect behavior pattern can include engagement points that specifically focus on consumer-product interactions. For example, an engagement point can be activated when a consumer brings a known product into view of their smart phone camera or augmented reality glasses. The engagement point allows presentation of product content directly to the consumer where the content could include available inventory information perhaps even indicating back ordered items. Still further, the engagement point interactions between the consumer and the product information can feed into other expected behavior patterns. A higher level expected behavior pattern might be associated with the retailer rather than a consumer or other end user. The retailer's expected behavior pattern might include one or more planogram engagement points. As the consumer interacts with a product, the context information related to the interaction can be used to establish the engagement point context associated with a specific planogram. The interactions could indicate the planogram is successful or not successful. In which case, a vendor could supply content in the form of vendor recommendations on better planograms to the retailer through the planogram engagement point's interaction interface. Still further the retailer's or the vendor's influence a suppliers expected behavior pattern by triggering engagement points representing replenishment orders.

In the previous inventory management example, the expected behavior patterns form a hierarchal structure. A retailer might instantiate an expected shopping behavior pattern for the consumer. The vendor could establish an expected inventory management behavior pattern for the retailer. The supplier could instantiate an expected product distribution behavior pattern for the vendor. The content providers for each level could be the entity at the next higher level, or other third parties (e.g., advertisers, brands, etc.).

Inventory management systems could also include expected behavior patterns representing planograms. The planogram expected behavior pattern might include engagement points that mirror expected stocking actions or placement of products on a shelf. As a stocker is placing products on a display or shelf, the stocker can be transitions from one engagement point to other reflecting progress along construction of the planogram. If there are deviations from the planogram, content in the form of suggestions or recommendations to correct the issue can be sent to the stocker.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An engagement point management system comprising:
an engagement point database storing a plurality of engagement points; and
an engagement engine coupled with the engagement point database and configured to:
obtain consumer behavior data;
derive a context from the consumer behavior data;
acquire a set of engagement points from the engagement point database as a function of the context;
instantiate an expected behavior pattern by linking engagement points in the set of engagement points according to a behavior rules set, each linked engagement point assigned a contextual engagement point signature;
configure at least some of the linked engagement points in the expected behavior pattern with at least one user interaction interface; and
configure a content server to present content via at least one user interaction interface upon satisfaction of the contextual engagement point signature of a corresponding linked engagement point.

2. The system of claim 1, wherein the engagement points comprise at least one of following: a user state, a consumer state, an environment state, a device state, a consumer state of mind, and a physical place.

3. The system of claim 1, wherein the behavior pattern comprises at least one of the following classes of engagement points: sports engagement points, gaming engagement points, travel engagement points, continuum of care engagement points, medical service engagement points, patient healthcare engagement points, education engagement points, life stage engagement points, and financial engagement points.

4. The system of claim 1, wherein the behavior pattern comprises shopping engagement points.

5. The system of claim 4, wherein the shopping engagement points comprise: an awareness point, a discovery point, an analysis point, a decision point, an in-store experience point, a selection point, a payment point, a follow up point, and a support point.

6. The system of claim 1, wherein user interact interface comprises an instantiated engagement point engine.

7. The system of claim 6, wherein the instantiated engagement point engine comprises at least one of the following: an awareness engine, a discovery engine, an analysis engine, a decision engine, an in-store experience engine, a selection engine, a payment engine, a follow up engine, and a support engine.

8. The system of claim 1, wherein the engagement engine is further configured to obtain the behavior data from at least one of the following: a mobile device, a vehicle, a kiosk, a computer, a sensor, a biometric hub, a loyalty program service, a healthcare analysis stream management engine, and a game device.

9. The system of claim 1, wherein the behavior data comprises at least one of the following modalities of data: image data, audio data, sensor data, location data, position data, orientation data, time data, text data, and ambient data.

10. The system of claim 1, wherein the context is selected from the group consisting of: a current context, a future context, and a past context.

11. The system of claim 1, wherein the engagement engine is further configured to create a new engagement point.

12. The system of claim 1, wherein the context comprises links to known engagement points.

13. The system of claim 1, wherein the behavior rule set comprises an a priori generated rule set.

14. The system of claim 1, wherein the engagement engine is further configured to construct the behavior rule set in substantially real-time upon receiving the consumer behavior data.

15. The system of claim 1, engagement engine is further configured to construct the behavior rule set as a function of the context.

16. The system of claim 1, wherein the user interaction interface comprises at least one of the following: a direct mail, a letter, a website, an email, a kiosk, a text message via cellular phone, a consumer service, and a mobile device application.

17. The system of claim 1, wherein the user interaction interface is configured to enable a third party marketer to submit the content to the user via the user interaction interface.

18. The system of claim 1, further comprising an engagement point purchasing server configured to accept fees with respect to the engagement points within the behavior pattern.

19. The system of claim 18, wherein the fees include at least one of the following: a per use charge, a bid, an auction result, a subscription, and a flat fee.

20. A method for providing a personalized consumer engagement experience comprising the steps of:
providing access to an engagement point database, wherein the engagement point database is configured to store a plurality engagement points;
configuring a computing device to operate as an engagement engine coupled with the engagement point database;
obtaining, by the engagement engine, consumer behavior data;
deriving, by the engagement engine, a context from the consumer behavior data;
acquiring, by the engagement engine, a set of engagement points from the engagement point database as a function of the context;
instantiating, by the engagement engine, an expected behavior pattern by linking engagement points in the set of engagement points according to a behavior rules set, each linked engagement point assigned a contextual engagement point signature;
configuring, by the engagement engine, at least some of the linked engagement points in the expected behavior pattern with at least one user interaction interface; and
configuring, by the engagement engine, a content server to present content via at least one user interaction interface upon satisfaction of the contextual engagement point signature of a corresponding linked engagement point.

21. A computer related product comprising a non-transitory computer readable medium storing instructions that cause a processor to execute the steps of:
maintaining an engagement point database storing a plurality engagement points;
configuring a computing device to operate as an engagement engine coupled with the engagement point database;
obtaining, by the engagement engine, a consumer behavior data;
deriving, by the engagement engine, a context from the consumer behavior data;
acquiring, by the engagement engine, a set of engagement points from the engagement point database as a function of the context;
instantiating, by the engagement engine, an expected behavior pattern by linking engagement points in the set of engagement points according to a behavior rules set, each linked engagement point assigned a contextual engagement point signature;
configuring, by the engagement engine, at least some of the linked engagement points in the expected behavior pattern with at least one user interaction interface; and
configuring, by the engagement engine, a content server to present content via at least one user interaction interface upon satisfaction of the contextual engagement point signature of a corresponding linked engagement point.
